(19) United States
(12) Patent Application Publication
(10) Pub. No.: US 2026/0222694 A1
(43) Pub. Date: Jul. 30, 2026

(54) MONITORING SYSTEM

(71) Applicant: TOYOTA JIDOSHA KABUSHIKI KAISHA, Toyota-shi (JP)

(72) Inventor: Satoshi NAITO, Yokohama-shi (JP)

(73) Assignee: TOYOTA JIDOSHA KABUSHIKI KAISHA, Toyota-shi (JP)

(21) Appl. No.: 19/407,224

(22) Filed: Dec. 3, 2025

(30) Foreign Application Priority Data
Jan. 29, 2025 (JP) 2025-013125

(51) Int. Cl. H04N 23/90; H04N 7/18; H04N 23/20; H04N 23/56; H04N 23/74

(52) U.S. Cl. CPC H04N 23/90; H04N 7/18; H04N 23/20; H04N 23/56; H04N 23/74

(57) ABSTRACT

In the infrared imaging of one infrared camera module among the first infrared camera module, the second infrared camera module, the third infrared camera module, and the fourth infrared camera module, at least control parameters of the first infrared camera module and the fourth infrared camera module in a case of performing the infrared imaging and control parameters of the second infrared camera module and the third infrared camera module are set to different control parameters such that the influence of the infrared rays emitted from the other infrared camera modules among the infrared camera modules is reduced.

### CROSS-REFERENCE TO RELATED APPLICATION

This application claims priority to Japanese Patent Application No. 2025-013125 filed on January 29, 2025. The disclosure of the above-identified application, including the specification, drawings, and claims, is incorporated by reference herein in its entirety.

### BACKGROUND

### 1. Technical Field

The present disclosure relates to a monitoring system.

### 2. Description of Related Art

Japanese Patent No. 6743708 (JP 6743708 B) discloses an imaging system that controls an infrared ray emission timing of an infrared camera module of each of vehicles as an imaging system in the related art. Specifically, by performing vehicle-to-vehicle communication between imaging control devices of the vehicles including the infrared camera modules that produce infrared images, an infrared ray emitted from an infrared camera module of one vehicle does not act as a disturbance in an infrared image captured by an infrared camera module of another vehicle and does not cause degradation in an image quality.

### SUMMARY

In a case where wide-range monitoring is performed for security and the like, a plurality of monitoring cameras is required, and in order to prevent omission of a monitoring location, parts of monitoring ranges of the monitoring cameras are required to overlap. In a case where an infrared camera module that emits an infrared ray to perform infrared imaging is used as the monitoring camera, in an overlapping part of the monitoring ranges, it is required to reduce degradation in an image quality of an infrared image captured by one infrared camera module due to an influence of an infrared ray emitted from another infrared camera module.

The present disclosure has been made in view of such problems, and an object thereof is to reduce degradation in an image quality of an infrared image in an overlapping part of monitoring ranges.

In order to solve the above-described problem, a monitoring system according to an aspect of the present disclosure monitors a monitoring range that is predetermined using an infrared camera module group including a plurality of infrared camera modules for emitting an infrared ray to perform infrared imaging. The infrared camera module group includes a first infrared camera module configured to monitor a first range within the monitoring range, a second infrared camera module configured to monitor a second range that overlaps with a part of a right side of the first range when the monitoring range is viewed from above, a third infrared camera module configured to monitor a third range that overlaps with a part of a lower side of the first range when the monitoring range is viewed from above, and a fourth infrared camera module configured to monitor a fourth range that overlaps with a lower side of the second range and a right side of the third range when the monitoring range is viewed from above. At least control parameters of the first infrared camera module and the fourth infrared camera module and control parameters of the second infrared camera module and the third infrared camera module when the infrared imaging is performed are set to different control parameters such that, in infrared imaging of one infrared camera module among the first infrared camera module, the second infrared camera module, the third infrared camera module, and the fourth infrared camera module, an influence of infrared rays emitted from other infrared camera modules among the first infrared camera module, the second infrared camera module, the third infrared camera module, and the fourth infrared camera module is reduced.

According to the aspect of the present disclosure, it is possible to reduce degradation in an image quality of an infrared image in an overlapping part of monitoring ranges.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of a monitoring system according to an embodiment of the present disclosure.

### DETAILED DESCRIPTION OF EMBODIMENTS

Hereinafter, an embodiment of the present disclosure will be described in detail with reference to the drawings. In the following description, the same reference numerals are given to the same constituent elements.

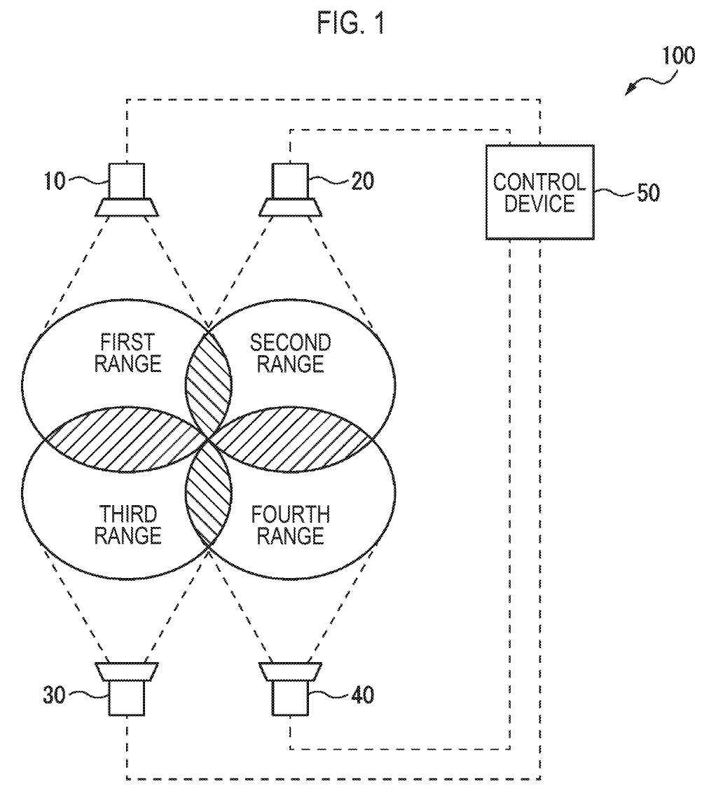

FIG. 1 is a schematic diagram of a monitoring system according to an embodiment of the present disclosure.

The monitoring system according to the present embodiment is a system that monitors a predetermined monitoring range, such as within a smart city or within a building, by an infrared camera module group 100 consisting of a plurality of infrared camera modules for emitting an infrared ray and performing infrared imaging.

As shown in FIG. 1, the infrared camera module group 100 includes a first infrared camera module 10 that monitors a first range in a monitoring range, a second infrared camera module 20 that monitors a second range that overlaps a part on a right side of the first range in a case of viewing the monitoring range from above, a third infrared camera module 30 that monitors a third range that overlaps a part on a lower side of the first range in a case of viewing the monitoring range from above, a fourth infrared camera module 40 that monitors a fourth range that overlaps a lower side of the second range and a right side of the third range in a case of viewing the monitoring range from above, and a control device 50 that controls these modules.

The first to fourth infrared camera modules 10 to 40 each include an infrared ray emitting diode that emits infrared light. The first to fourth infrared camera modules 10 to 40 respond to an imaging instruction signal from the control device 50 to emit an infrared ray having a predetermined wavelength toward respective imaging ranges, and selectively receive the infrared ray having the predetermined wavelength reflected from a subject by an optical filter or the like to perform infrared imaging. In this case, the first to fourth infrared camera modules 10 to 40 may be configured to limit a polarization direction of the infrared ray to be further emitted to a specific direction determined in advance by a polarization filter or the like, and selectively receive the infrared ray having the specific polarization direction reflected from the subject to perform infrared imaging. The first to fourth infrared camera modules 10 to 40 transmit the infrared image produced by the infrared imaging to the control device 50.

The control device 50 is, for example, a general-purpose computer, transmits an imaging instruction signal to the first to fourth infrared camera modules 10 to 40, and sets control parameters of the first to fourth infrared camera modules 10 to 40, which will be described below.

In a case of performing wide-range monitoring for security and the like, a plurality of monitoring cameras are required, and in order to prevent omission of a monitoring location, a part of a monitoring range of each monitoring camera needs to overlap. In a case where the infrared camera module is used as the monitoring camera as in the present embodiment, in an overlapping part of the monitoring ranges, it is necessary to prevent the image quality of the infrared image captured by the other infrared camera module from being degraded due to the influence of the infrared ray emitted from one infrared camera module.

Therefore, in the present embodiment, the control parameters of the first to fourth infrared camera modules 10 to 40 are set such that the influence of the infrared rays emitted from the other infrared camera module among the first to fourth infrared camera modules 10 to 40 is reduced in the infrared imaging of one infrared camera module among the first to fourth infrared camera modules 10 to 40. Examples of the control parameters of the first to fourth infrared camera modules 10 to 40 include a wavelength WL of the infrared rays emitted from the first to fourth infrared camera modules 10 to 40, a polarization direction PD of the infrared rays emitted from the first to fourth infrared camera modules 10 to 40, and an imaging timing ST of the first to fourth infrared camera modules 10 to 40.

Hereinafter, a case where the wavelength WL of the infrared rays emitted from the first to fourth infrared camera modules 10 to 40 is set as the control parameters of the first to fourth infrared camera modules 10 to 40 will be described.

In this case, for example, the wavelength WL of the infrared rays emitted from the first infrared camera module 10 and the fourth infrared camera module 40 is set to a first wavelength WL1 (for example, 850 [nm]), and the wavelength WL of the infrared rays emitted from the second infrared camera module 20 and the third infrared camera module 30 is set to a second wavelength WL2 (for example, 940 [nm]) different from the first wavelength WL1.

As a result, the wavelength WL (second wavelength WL2) of the infrared rays emitted from the second infrared camera module 20 and the third infrared camera module 30 that monitor the second range and the third range overlapping a part of the first range can be set to a wavelength different from the wavelength WL (first wavelength WL1) of the infrared rays emitted from the first infrared camera module 10. In addition, the wavelength WL (second wavelength WL2) of the infrared rays emitted from the second infrared camera module 20 and the third infrared camera module 30 that monitor the second range and the third range overlapping a part of the fourth range can be set to a wavelength different from the wavelength WL (first wavelength WL1) of the infrared ray emitted from the fourth infrared camera module 40.

Therefore, it is possible to suppress the degradation of the infrared image in an overlapping part of the first range and the second range and an overlapping part of the first range and the third range. In addition, it is possible to suppress the degradation of the infrared image in an overlapping part of the fourth range and the second range and an overlapping part of the fourth range and the third range.

Further, since the four ranges of the first to fourth ranges can be monitored using two types of wavelengths (first wavelength WL1 and second wavelength WL2), it is possible to suppress the degradation of the infrared image in an overlapping part of the first to fourth ranges even in a case where the number of options for the wavelength WL of the infrared ray emitted from the infrared camera module is small, for example, in a case where there are only two options for the wavelength WL of the infrared ray.

In a case where there are three options for the wavelength WL of the infrared ray emitted from the infrared camera module, the wavelength WL of the infrared ray emitted from the first infrared camera module 10 is set to the first wavelength WL1, the wavelength WL of the infrared ray emitted from the second infrared camera module 20 and the third infrared camera module 30 is set to the second wavelength WL2, and the wavelength WL of the infrared ray emitted from the fourth infrared camera module 40 is set to a third wavelength WL3 different from the first wavelength WL1 and the second wavelength WL2, so that it is possible to suppress the degradation of the infrared image in an overlapping part of the first range and the fourth range even in a case where the first range and the fourth range partially overlap due to some factor.

In addition, in a case where there are four options for the wavelength WL of the infrared ray emitted from the infrared camera module, the wavelength of each of the first to fourth infrared camera modules 10 to 40 is made different from each other, so that it is possible to suppress the degradation of the infrared image in all overlapping parts of the imaging ranges of the first to fourth ranges.

Next, a case where the polarization direction PD of the infrared rays emitted from the first to fourth infrared camera modules 10 to 40 is set as the control parameters of the first to fourth infrared camera modules 10 to 40 will be described.

In this case, for example, the polarization direction PD of the infrared rays emitted from the first infrared camera module 10 and the fourth infrared camera module 40 is set to a first polarization direction PD1, and the polarization direction PD of the infrared rays emitted from the second infrared camera module 20 and the third infrared camera module 30 is set to a second polarization direction PD2 different from the first polarization direction PD1.

As a result, the polarization direction PD (second polarization direction PD2) of the infrared rays emitted from the second infrared camera module 20 and the third infrared camera module 30 that monitor the second range and the third range overlapping a part of the first range can be set to a polarization direction different from the polarization direction PD (first polarization direction PD1) of the infrared ray emitted from the first infrared camera module 10. In addition, the polarization direction PD (second polarization direction PD2) of the infrared rays emitted from the second infrared camera module 20 and the third infrared camera module 30 that monitor the second range and the third range overlapping a part of the fourth range can be set to a polarization direction PD different from the polarization direction PD (first polarization direction PD1) of the infrared ray emitted from the fourth infrared camera module 40.

As a result, since the four ranges of the first to fourth ranges can be monitored using two types of polarization directions (first polarization direction PD1 and second polarization direction PD2), it is possible to suppress the degradation of the infrared image in an overlapping part of the first range and the second range and an overlapping part of the first range and the third range even in a case where there is only one option for the wavelength WL of the infrared rays emitted from the first to fourth infrared camera modules 10 to 40. In addition, it is possible to suppress the degradation of the infrared image in an overlapping part of the fourth range and the second range and an overlapping part of the fourth range and the third range.

In a case where there are three options for the polarization direction PD of the infrared ray emitted from the infrared camera module, the polarization direction PD of the infrared ray emitted from the first infrared camera module 10 is set to the first polarization direction PD1, the polarization direction PD of the infrared rays emitted from the second infrared camera module 20 and the third infrared camera module 30 is set to the second polarization direction PD2, and the polarization direction PD of the infrared ray emitted from the fourth infrared camera module 40 is set to a third polarization direction PD3 different from the first polarization direction PD1 and the second polarization direction PD2, so that it is possible to suppress the degradation of the infrared image in an overlapping part of the first range and the fourth range even in a case where the first range and the fourth range partially overlap due to some factor.

In addition, in a case where there are four options for the polarization direction PD of the infrared ray emitted from the infrared camera module, the wavelength of each of the first to fourth infrared camera modules 10 to 40 is made different from each other, so that it is possible to suppress the degradation of the infrared image in all overlapping parts of the imaging ranges of the first to fourth ranges.

Next, a case where the imaging timing ST of the first to fourth infrared camera modules 10 to 40 is set as the control parameters of the first to fourth infrared camera modules 10 to 40 will be described.

In this case, in a case where a time during which the infrared light is emitted and exposure is performed by the infrared camera module is referred to as an "imaging time" of the infrared imaging by the infrared camera module, an imaging instruction signal is simultaneously transmitted to the first infrared camera module 10 and the fourth infrared camera module 40 to start the infrared imaging of the first infrared camera module 10 and the fourth infrared camera module 40, and after the imaging time has elapsed, an imaging instruction signal is simultaneously transmitted to the second infrared camera module 20 and the third infrared camera module 30 to start the infrared imaging of the second infrared camera module 20 and the third infrared camera module 30. That is, a timing shifted from the first imaging timing ST1 at which the imaging instruction signal is transmitted to the first infrared camera module 10 and the fourth infrared camera module 40 by at least the imaging time is set as the second imaging timing ST2 at which the imaging instruction signal is transmitted to the second infrared camera module 20 and the third infrared camera module 30.

Then, after the imaging time has further elapsed since the infrared imaging of the second infrared camera module 20 and the third infrared camera module 30 is started, the imaging instruction signal is transmitted to the first infrared camera module 10 and the fourth infrared camera module 40 again to start the infrared imaging of the first infrared camera module 10 and the fourth infrared camera module 40. That is, a timing shifted from the second imaging timing ST2 by at least the imaging time is set as the next first imaging timing ST1.

This is repeated to shift the imaging timing ST such that the imaging time of the first infrared camera module 10 and the fourth infrared camera module 40 does not overlap with the imaging time of the second infrared camera module 20 and the third infrared camera module 30. As a result, the exposure of the infrared imaging by the first infrared camera module 10 and the fourth infrared camera module 40 is not affected by the infrared rays emitted from the second infrared camera module 20 and the third infrared camera module 30, and the exposure of the infrared imaging by the second infrared camera module 20 and the third infrared camera module 30 is not affected by the infrared rays emitted from the first infrared camera module 10 and the fourth infrared camera module 40.

As a result, even in a case where there is only one option for the wavelength WL and the polarization direction PD of the infrared rays emitted from the first to fourth infrared camera modules 10 to 40, it is possible to suppress the degradation of the infrared image in an overlapping part of the first range and the second range and an overlapping part of the first range and the third range, and it is possible to suppress the degradation of the infrared image in an overlapping part of the fourth range and the second range and an overlapping part of the fourth range and the third range.

In a case where the infrared imaging is performed in order of the first infrared camera module 10 → the second infrared camera module 20 and the third infrared camera module 30 → the fourth infrared camera module 40 such that the imaging time of the first infrared camera module 10, the imaging time of the second infrared camera module 20 and the third infrared camera module 30, and the imaging time of the fourth infrared camera module 40 do not overlap, it is possible to suppress the degradation of the infrared image in an overlapping part of the first range and the fourth range even in a case where the first range and the fourth range partially overlap due to some factor.

In addition, in a case where the infrared imaging is performed in order of the first infrared camera module 10 → the second infrared camera module 20 → the third infrared camera module 30 → the fourth infrared camera module 40 such that the imaging times of all the infrared camera modules do not overlap, it is possible to suppress the degradation of the infrared image in all overlapping parts of the imaging ranges of the first to fourth ranges.

The imaging order of the first to fourth infrared camera modules 10 to 40 described above is merely an example, and the imaging order is not limited to such an imaging order.

Next, a case where two of the wavelength WL and the polarization direction PD of the infrared rays emitted from the first to fourth infrared camera modules 10 to 40 are set as the control parameters of the first to fourth infrared camera modules 10 to 40 will be described.

In this case, for example, the wavelength WL of the infrared rays emitted from the first infrared camera module 10 and the fourth infrared camera module 40 is set to the first wavelength WL1, and the wavelength WL of the infrared rays emitted from the second infrared camera module 20 and the third infrared camera module 30 is set to the second wavelength WL2 different from the first wavelength WL1. Then, the polarization direction PD of the infrared rays emitted from the first infrared camera module 10 and the third infrared camera module 30 is set to the first polarization direction PD1, and the polarization direction PD of the infrared rays emitted from the second infrared camera module 20 and the fourth infrared camera module 40 is set to the second polarization direction PD2.

As a result, it is possible to suppress the degradation of the infrared image in an overlapping part of the first range and the second range and an overlapping part of the first range and the third range in which the wavelengths WL of the infrared rays are different. Similarly, it is possible to suppress the degradation of the infrared image in an overlapping part of the fourth range and the second range and an overlapping part of the fourth range and the third range in which the wavelengths WL of the infrared rays are different.

Further, since the polarization direction PD of the first infrared camera module 10 and the fourth infrared camera module 40 in which the wavelengths WL of the infrared rays are the same, can be set to different polarization directions (first polarization direction PD1 and second polarization direction PD2), it is possible to suppress the degradation of the infrared image in an overlapping part of the first range and the fourth range even in a case where the first range and the fourth range partially overlap due to some factor. Similarly, since the polarization direction PD of the second infrared camera module 20 and the third infrared camera module 30 in which the wavelengths WL of the infrared rays are the same, can be set to different polarization directions (first polarization direction PD1 and second polarization direction PD2), it is possible to suppress the degradation of the infrared image in an overlapping part of the second range and the third range even in a case where the second range and the third range partially overlap due to some factor.

As a result, in a case where there are two options for each of the wavelength WL and the polarization direction PD of the infrared ray emitted from the infrared camera module, it is possible to suppress the degradation of the infrared image in all overlapping parts of the imaging ranges of the first to fourth ranges.

Next, a case where two of the wavelength WL of the infrared rays emitted from the first to fourth infrared camera modules 10 to 40 and the imaging timing ST of the first to fourth infrared camera modules 10 to 40 are set as the control parameters of the first to fourth infrared camera modules 10 to 40 will be described.

In this case, for example, the wavelength WL of the infrared rays emitted from the first infrared camera module 10 and the fourth infrared camera module 40 is set to the first wavelength WL1, and the wavelength WL of the infrared rays emitted from the second infrared camera module 20 and the third infrared camera module 30 is set to the second wavelength WL2 different from the first wavelength WL1. Then, the imaging timing of the first infrared camera module 10 and the third infrared camera module 30 is set to the first imaging timing ST1, and the imaging timing of the second infrared camera module 20 and the fourth infrared camera module 40 is set to the second imaging timing ST2 different from the first imaging timing.

As a result, it is possible to suppress the degradation of the infrared image in an overlapping part of the first range and the second range and an overlapping part of the first range and the third range in which the wavelengths WL of the infrared rays are different. Similarly, it is possible to suppress the degradation of the infrared image in an overlapping part of the fourth range and the second range and an overlapping part of the fourth range and the third range in which the wavelengths WL of the infrared rays are different.

Further, since the imaging timing ST of the first infrared camera module 10 and the fourth infrared camera module 40 in which the wavelengths WL of the infrared rays are the same, can be set to different imaging timings (first imaging timing ST1 and second imaging timing ST2), it is possible to suppress the degradation of the infrared image in an overlapping part of the first range and the fourth range even in a case where the first range and the fourth range partially overlap due to some factor. Similarly, since the imaging timing ST of the second infrared camera module 20 and the third infrared camera module 30 in which the wavelengths WL of the infrared rays are the same, can be set to different imaging timings (first imaging timing ST1 and second imaging timing ST2), it is possible to suppress the degradation of the infrared image in an overlapping part of the second range and the third range even in a case where the second range and the third range partially overlap due to some factor.

As a result, in a case where there are two options for the wavelength WL of the infrared ray emitted from the infrared camera module, it is possible to suppress the degradation of the infrared image in all overlapping parts of the imaging ranges of the first to fourth ranges.

Finally, a case where two of the polarization direction PD of the infrared rays emitted from the first to fourth infrared camera modules 10 to 40 and the imaging timing ST of the first to fourth infrared camera modules 10 to 40 are set as the control parameters of the first to fourth infrared camera modules 10 to 40 will be described.

In this case, for example, the polarization direction PD of the infrared rays emitted from the first infrared camera module 10 and the fourth infrared camera module 40 is set to a first polarization direction PD1, and the polarization direction PD of the infrared rays emitted from the second infrared camera module 20 and the third infrared camera module 30 is set to a second polarization direction PD2 different from the first polarization direction PD1. Then, the imaging timing ST of the first infrared camera module 10 and the third infrared camera module 30 is set to the first imaging timing ST1, and the imaging timing ST of the second infrared camera module 20 and the fourth infrared camera module 40 is set to the second imaging timing ST2 different from the first imaging timing.

As a result, it is possible to suppress the degradation of the infrared image in an overlapping part of the first range and the second range and an overlapping part of the first range and the third range in which the polarization directions PD of the infrared rays are different. Similarly, it is possible to suppress the degradation of the infrared image in an overlapping part of the fourth range and the second range and an overlapping part of the fourth range and the third range in which the polarization directions PD of the infrared rays are different.

Further, since the imaging timing ST of the first infrared camera module 10 and the fourth infrared camera module 40 in which the polarization directions PD of the infrared rays are the same, can be set to different imaging timings (first imaging timing ST1 and second imaging timing ST2), it is possible to suppress the degradation of the infrared image in an overlapping part of the first range and the fourth range even in a case where the first range and the fourth range partially overlap due to some factor. Similarly, since the imaging timing ST of the second infrared camera module 20 and the third infrared camera module 30 in which the polarization directions PD of the infrared rays are the same, can be set to different imaging timings (first imaging timing ST1 and second imaging timing ST2), it is possible to suppress the degradation of the infrared image in an overlapping part of the second range and the third range even in a case where the second range and the third range partially overlap due to some factor.

As a result, in a case where there are two options for the polarization direction PD of the infrared ray emitted from the infrared camera module, it is possible to suppress the degradation of the infrared image in all overlapping parts of the imaging ranges of the first to fourth ranges.

The monitoring system according to the present embodiment monitors a predetermined monitoring range with an infrared camera module group 100 consisting of a plurality of infrared camera modules for emitting an infrared ray and performing infrared imaging. The infrared camera module group 100 includes a first infrared camera module 10 that monitors a first range in a monitoring range, a second infrared camera module 20 that monitors a second range that overlaps a part on a right side of the first range in a case of viewing the monitoring range from above, a third infrared camera module 30 that monitors a third range that overlaps a part on a lower side of the first range in a case of viewing the monitoring range from above, and a fourth infrared camera module 40 that monitors a fourth range that overlaps a lower side of the second range and a right side of the third range in a case of viewing the monitoring range from above. In the infrared imaging of one infrared camera module among the first infrared camera module 10, the second infrared camera module 20, the third infrared camera module 30, and the fourth infrared camera module, at least control parameters of the first infrared camera module 10 and the fourth infrared camera module 40 in a case of performing the infrared imaging and control parameters of the second infrared camera module 20 and the third infrared camera module 30 are set to different control parameters such that the influence of the infrared rays emitted from the other infrared camera module among the infrared camera modules is reduced.

As a result, the control parameters of the second and third infrared camera modules 20, 30 that monitor the second range and the third range overlapping the first range can be set to appropriate control parameters different from the first infrared camera module 10, so that it is possible to suppress the degradation of the infrared image in an overlapping part of the first range and the second range and an overlapping part of the first range and the third range. Similarly, the control parameters of the second and third infrared camera modules 20, 30 that monitor the second range and the third range overlapping the fourth range can be set to appropriate control parameters different from the fourth infrared camera module 40, so that it is possible to suppress the degradation of the infrared image in an overlapping part of the fourth range and the second range and an overlapping part of the fourth range and the third range. As a result, it is possible to monitor a wide monitoring range uniformly with high-quality infrared images.

Specifically, the control parameters can be configured by, for example, a combination of the wavelength WL of the infrared rays emitted from the first to fourth infrared camera modules 10 to 40 and the polarization direction PD of the infrared rays emitted from the first to fourth infrared camera modules 10 to 40. In this case, the wavelength WL of the infrared rays emitted from the first infrared camera module 10 and the fourth infrared camera module 40 is set to the first wavelength WL1, the wavelength WL of the infrared rays emitted from the second infrared camera module 20 and the third infrared camera module 30 is set to the second wavelength WL2 different from the first wavelength WL1, the polarization direction PD of the infrared rays emitted from the first infrared camera module 10 and the third infrared camera module 30 is set to the first polarization direction PD1, and the polarization direction PD of the infrared rays emitted from the second infrared camera module 20 and the fourth infrared camera module 40 is set to the second polarization direction PD2 different from the first polarization direction PD1.

In this way, the control parameters of each infrared camera module of the first to fourth infrared camera modules 10 to 40 can be set to different control parameters. Therefore, it is possible to suppress the degradation of the infrared image in all overlapping parts of the imaging ranges of the first to fourth ranges.

In addition, the control parameters can be configured by, for example, a combination of the wavelength WL of the infrared rays emitted from the first to fourth infrared camera modules 10 to 40 and the imaging timing ST of the first to fourth infrared camera modules 10 to 40. In this case, the wavelength WL of the infrared rays emitted from the first infrared camera module 10 and the fourth infrared camera module 40 is set to the first wavelength WL1, the wavelength WL of the infrared rays emitted from the second infrared camera module 20 and the third infrared camera module 30 is set to the second wavelength WL2 different from the first wavelength WL1, the imaging timing ST of the first infrared camera module 10 and the third infrared camera module 30 is set to the first imaging timing ST1, and the imaging timing ST of the second infrared camera module 20 and the fourth infrared camera module 40 is set to the second imaging timing ST2 different from the first imaging timing ST1.

In this way, in a case where there are two options for the wavelength WL of the infrared ray emitted from the infrared camera module, the control parameters of each infrared camera module of the first to fourth infrared camera modules 10 to 40 can be set to different control parameters. Therefore, it is possible to suppress the degradation of the infrared image in all overlapping parts of the imaging ranges of the first to fourth ranges.

In addition, the control parameters can be configured by, for example, a combination of the polarization direction PD of the infrared rays emitted from the first to fourth infrared camera modules 10 to 40 and the imaging timing ST of the first to fourth infrared camera modules 10 to 40. In this case, the polarization direction PD of the infrared rays emitted from the first infrared camera module 10 and the fourth infrared camera module 40 is set to the first polarization direction PD1, the polarization direction PD of the infrared rays emitted from the second infrared camera module 20 and the third infrared camera module 30 is set to the second polarization direction PD2 different from the first polarization direction PD1, the imaging timing ST of the first infrared camera module 10 and the third infrared camera module 30 is set to the first imaging timing ST1, and the imaging timing ST of the second infrared camera module 20 and the fourth infrared camera module 40 is set to the second imaging timing ST2 different from the first imaging timing ST1.

In this way, in a case where there are two options for the polarization direction PD of the infrared ray emitted from the infrared camera module, the control parameters of each infrared camera module of the first to fourth infrared camera modules 10 to 40 can be set to different control parameters. Therefore, it is possible to suppress the degradation of the infrared image in all overlapping parts of the imaging ranges of the first to fourth ranges.

Although the embodiments of the disclosure have been described above, the above embodiments merely show a part of application examples of the disclosure, and are not intended to limit the technical scope of the disclosure to the specific configurations of the embodiments.

For example, in the above-described embodiment, a wider range may be monitored by a plurality of infrared camera module groups 100. In this case, for example, it is sufficient that there is no omission in the monitoring range by overlapping a part of the second range and the fourth range of one infrared camera module group 100 with a part of the first range and the third range of the other infrared camera module group 100.

What is claimed is:

1. A monitoring system that monitors a monitoring range that is predetermined using an infrared camera module group including a plurality of infrared camera modules for emitting an infrared ray to perform infrared imaging, wherein:
the infrared camera module group includes
a first infrared camera module configured to monitor a first range within the monitoring range,
a second infrared camera module configured to monitor a second range that overlaps with a part of a right side of the first range when the monitoring range is viewed from above,
a third infrared camera module configured to monitor a third range that overlaps with a part of a lower side of the first range when the monitoring range is viewed from above, and
a fourth infrared camera module configured to monitor a fourth range that overlaps with a lower side of the second range and a right side of the third range when the monitoring range is viewed from above; and
control parameters of the first infrared camera module and the fourth infrared camera module and control parameters of the second infrared camera module and the third infrared camera module when the infrared imaging is performed are set to different control parameters such that, in infrared imaging of one infrared camera module among the first infrared camera module, the second infrared camera module, the third infrared camera module, and the fourth infrared camera module, an influence of infrared rays emitted from other infrared camera modules among the first infrared camera module, the second infrared camera module, the third infrared camera module, and the fourth infrared camera module is reduced.

2. The monitoring system according to claim 1, wherein wavelengths of infrared rays emitted from the first infrared camera module and the fourth infrared camera module are set to wavelengths different from wavelengths of infrared rays emitted from the second infrared camera module and the third infrared camera module, polarization directions of the infrared rays emitted from the first infrared camera module and the fourth infrared camera module are set to polarization directions different from polarization directions of the infrared rays emitted from the second infrared camera module and the third infrared camera module, or imaging timings of the first infrared camera module and the fourth infrared camera module are set to imaging timings different from imaging timings of the second infrared camera module and the third infrared camera module.

3. The monitoring system according to claim 1, wherein:
the control parameters are constituted by combinations of wavelengths of infrared rays emitted from the first infrared camera module, the second infrared camera module, the third infrared camera module, and the fourth infrared camera module and imaging timings of the first infrared camera module, the second infrared camera module, the third infrared camera module, and the fourth infrared camera module;
wavelengths of infrared rays emitted from the first infrared camera module and the fourth infrared camera module are set to first wavelengths;
wavelengths of infrared rays emitted from the second infrared camera module and the third infrared camera module are set to second wavelengths different from the first wavelengths;
imaging timings of the first infrared camera module and the third infrared camera module are set to first imaging timings; and
imaging timings of the second infrared camera module and the fourth infrared camera module are set to second imaging timings different from the first imaging timings.

4. The monitoring system according to claim 1, wherein:
the control parameters are constituted by combinations of wavelengths of infrared rays emitted from the first infrared camera module, the second infrared camera module, the third infrared camera module, and the fourth infrared camera module and polarization directions of the infrared rays emitted from the first infrared camera module, the second infrared camera module, the third infrared camera module, and the fourth infrared camera module;
wavelengths of infrared rays emitted from the first infrared camera module and the fourth infrared camera module are set to first wavelengths;
wavelengths of infrared rays emitted from the second infrared camera module and the third infrared camera module are set to second wavelengths different from the first wavelengths;
polarization directions of infrared rays emitted from the first infrared camera module and the third infrared camera module are set to first polarization directions; and
polarization directions of infrared rays emitted from the second infrared camera module and the fourth infrared camera module are set to second polarization directions different from the first polarization directions.

5. The monitoring system according to claim 1, wherein:
the control parameters are constituted by combinations of imaging timings of the first infrared camera module, the second infrared camera module, the third infrared camera module, and the fourth infrared camera module and polarization directions of infrared rays emitted from the first infrared camera module, the second infrared camera module, the third infrared camera module, and the fourth infrared camera module;
imaging timings of the first infrared camera module and the fourth infrared camera module are set to first imaging timings;
imaging timings of the second infrared camera module and the third infrared camera module are set to second imaging timings different from the first imaging timings;
polarization directions of infrared rays emitted from the first infrared camera module and the third infrared camera module are set to first polarization directions; and
polarization directions of infrared rays emitted from the second infrared camera module and the fourth infrared camera module are set to second polarization directions different from the first polarization directions.
